(19) United States
(12) Patent Application Publication
(10) Pub. No.: US 2008/0265499 A1
(43) Pub. Date: Oct. 30, 2008

(54) IMAGE FORMING APPARATUS

(75) Inventor: Tadashi Sugiyama, Sunto-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/741,050

(22) Filed: Apr. 27, 2007

(51) Int. Cl. B65H 7/12; B41F 13/00

(52) U.S. Cl. 271/262; 271/265.01; 270/1.01

(57) ABSTRACT

The paper thickness of a medium to be recorded is detected, and the pressurization force of a conveyance roller is controlled. When a thick paper is detected, the pressurization force of the conveyance roller is made high. When a normal paper or a thin paper is detected, the pressurization force of the conveyance roller is decreased or the pressurization is released.

### BACKGROUND OF THE INVENTION

1. Field of the Invention

The present invention relates to an image forming apparatus having a function of determining the kind of a medium to be recorded.

2. Description of the Related Art

When the number of kinds of sheets handled by one image forming apparatus is increased, compatibility becomes difficult, and a problem occurs in either of or both of a thick paper and a thin paper.

In the tough thick paper, for example, unless a conveyance force by a conveyance roller is increased as compared with a case of a normal paper, poor conveyance occurs.

On the other hand, in the weak normal paper or thin paper, when the conveyance force by the conveyance roller is excessively high, there occur harmful effects such as occurrence of sheet wrinkles and roller tracks.

It is conceivable that as a control method of the conveyance force, the pressurization force of the conveyance roller to convey a sheet is adjusted.

For example, in some small printer for personal use, such as an impact dot printer or an ink jet printer, a user is made to manually perform the adjustment of a pressurization force in accordance with the kind of a sheet (for example, JP-A-2004-294426).

It is very troublesome to manually perform, for example, the adjustment of the pressurization force of the conveyance roller each time the kind of the sheet is changed.

### BRIEF SUMMARY OF THE INVENTION

It is an object of the present invention to provide an image forming apparatus in which conveyance control according to the kind of a medium to be recorded is performed.

In an aspect of the present invention, an image forming apparatus including an image forming unit and for performing conveyance control according to the kind of a medium to be recorded, includes

a media sensor to detect a paper thickness of the fed medium to be recorded,

a conveyance roller to convey the medium to be recorded to the image forming unit,

a pressurization force member to apply a pressurization force to the conveyance roller, and

an adjustment mechanism to adjust the pressurization force of the pressurization force member according to the paper thickness of the medium to be recorded detected by the media sensor.

### DESCRIPTION OF THE DRAWINGS

FIG. 1 is a structural view showing the outline of the whole structure of an image forming apparatus according to an embodiment of the invention.

FIG. 2 is a view showing a structure of an adjustment unit of a pressurization force of a sheet conveyance roller.

FIG. 3 is a view for explaining adjustment of the pressurization force of the sheet conveyance roller.

FIG. 4 is a view for explaining adjustment of the pressurization force of the sheet conveyance roller.

FIG. 5 is a view showing an example of a display of a control panel.

FIG. 6 is a view showing an example of a disposed position of a media sensor.

FIG. 7 is a view showing an example of a disposed position of a media sensor.

### DETAILED DESCRIPTION OF THE INVENTION

Throughout this description, the embodiments and examples shown should be considered as exemplars, rather than limitations on the apparatus and methods of the present invention.

Hereinafter, an embodiment of an image forming apparatus of the invention will be described in detail with reference to the drawings.

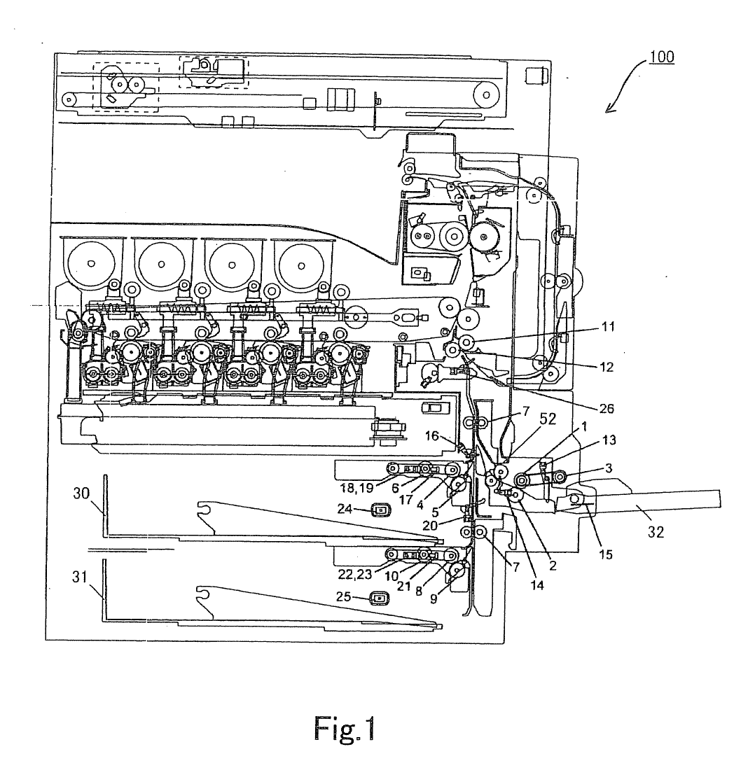

FIG. 1 is a sectional view showing a rough structure of an image forming apparatus 100 according to an embodiment. As shown in FIG. 1, the image forming apparatus 100 includes sheet cassettes 30 and 31, paper feed rollers 1, 4 and 8, a transfer belt drive roller, a transfer belt, photosensitive drums of yellow, magenta, cyan and black, a transfer roller, cartridges of yellow, magenta, cyan and black, optical units of yellow, magenta, cyan and black, and a fixing unit.

The image forming apparatus 100 uses a xerographic process to superimpose and transfer images of yellow, magenta, cyan and black onto a medium to be recorded, and thermally fixes the toner image by a fixing unit based on temperature control.

The optical unit of each color is constructed such that the surface of each of the photoconductive drums is exposed to and scanned with a laser beam, and a latent image is formed. In these series of image forming operations, the scan control is synchronously performed so that the image is transferred from a previously determined position on the conveyed recording paper.

Further, the image forming apparatus 100 includes a paper feed motor to feed and convey the recording paper as the medium to be recorded, a transfer belt drive motor to drive the transfer belt drive roller, a photoconductive drum drive motor to drive the photoconductive drum of each color and the transfer roller, and a fixing drive motor to drive the fixing roller.

A control CPU of the image forming apparatus 100 causes the fixing unit to give a desired amount of heat to the recording paper, so that the toner image on the recording paper is fused and fixed.

The fixing unit includes a nip part including a press roller and a heat roller, and the medium to be recorded is made to pass through the nip part, so that the medium to be recorded is heated and pressed, and the recorded image is fixed on the medium to be recorded. However, the fixing unit is not limited to the structure as stated above, and may include, for example, a nip part including a heat pad and a film-like member.

### (Structure of Paper Feed System)

Next, the structure of a paper feed system will be described in detail.

A sheet set on the paper feed cassette 30 or 31, or a manual feed tray 32 is conveyed to a secondary transfer position. The paper feed system mainly includes pickup rollers 3, 6 and 10, the paper feed rollers 1, 4 and 8, separation rollers 2, 5 and 9, conveyance rollers 7 and 15, register rollers 11 and 12, a manual feed sensor 13, cassette empty sensors 18 and 22, cassette near-empty sensors 19 and 23, a manual feed sensor 14, a cassette paper feed sensor 16, a register sensor 26, and their drive mechanisms.

The pickup rollers 3 and 6, the paper feed rollers 1, 4 and 8, and the conveyance rollers 7 and 15 are driven by paper feed and conveyance motors (not shown).

The pickup roller 3 or 6 is a roller to draw the sheet on the manual feed tray 32 or the paper feed cassette 30 or 31 to the paper feed roller 1, 4 or 8. The pickup rollers 3 and 6 move up and down at the time of paper feeding.

The paper feed roller 1, 4 or 8 conveys the sheet sent by the pickup roller 3 or 6 to the conveyance roller 7 or 15. The paper feed rollers 1, 4 and 8 are opposite to the separation rollers 2, 5 and 9.

The separation rollers 2, 5 and 9 are for preventing the overlapping conveyance of sheets. That is, in the case where two or more sheets are sent from the pickup roller 3 or 6, since the load of a torque limiter of the separation roller 2, 5 or 9 becomes large by the friction force between the sheet and the sheet, the separation roller 2, 5 or 9 is stopped. By this, the lower sheet is not conveyed any more, and the overlapping conveyance of the sheets is prevented. In the case where one sheet is conveyed from the pickup roller 3 or 6, the separation roller 2, 5 or 9 is rotated in accordance with the rotation of the paper feed roller 1, 4 or 8.

The conveyance roller 7 or 15 is for conveying the sheet sent by the paper feed roller 1, 4 or 8 to the register rollers 11 and 12.

The register rollers 11 and 12 are for adjusting the sheet, and the sheet sent by the conveyance roller 7 or 15 collides with the register rollers 11 and 12 at rest, and the position of the leading end is adjusted. Thereafter, the register rollers 11 and 12 are rotated, and the sheet is conveyed to the transfer position.

The manual feed sensor 13 is a sensor for detecting that the sheet is set on the manual feed tray 32. When the sheet is on the manual feed tray 32, the manual paper feed takes precedence over the cassette paper feed.

The presence or absence of a sheet in the paper feed cassette 30 or 31 is detected by the empty sensor 18 or 22. The empty sensor 18 or 22 is, for example, a transmission sensor, and in the case where there is no sheet in the paper feed cassette 30 or 31, an actuator blocks a light path of the transmission sensor, and it is determined that there is no sheet. The remaining amount of sheets in the paper feed cassette 30 or 31 can be detected in the same way.

The paper feed sensor 16 detects that the leading end and the trailing end of the sheet passes through the paper feed roller. It can also be used for jam detection of a paper feed miss or the like.

The register sensor 26 detects that the leading end of the sheet reaches the register rollers 11 and 12. Similarly, it can also detect that the trailing end of the sheet passes through the register rollers 11 and 12.

At the time of rising of the tray, it is necessary to stop the tray at a regulated height. Then, a cassette tray up sensor (not shown) is provided, and when the sensor is turned ON, a tray up motor (not shown) stops the rising. That the cassette is inserted is detected by a cassette detection switch (not shown).

The driving from the paper feed and conveyance motor is transmitted to the pickup rollers 6 and 10, and the paper feed rollers 4 and 8 through a cassette paper feed clutch (not shown).

The driving from the paper feed and conveyance motor is transmitted to the conveyance roller 7 through a cassette conveyance clutch (not shown). When the cassette conveyance clutch is turned ON, the conveyance roller 7 is rotated and the sheet is conveyed.

The driving from the paper feed and conveyance motor is transmitted to the conveyance roller 7 through the cassette conveyance clutch. After the position of the sheet is adjusted by the register rollers 11 and 12, the cassette conveyance clutch is turned OFF, and the clutch is turned ON. The conveyance roller 7 is rotated, and the sheet is conveyed.

The register rollers 11 and 12 are driven by a register motor (not shown). When the register motor normally rotates, the register rollers 11 and 12 are rotated. The register motor reversely rotates, a secondary transfer roller comes in contact with and separated from a contact transfer belt.

When the tray up motor normally rotates, the tray in the first cassette goes up. When the tray up motor reversely rotates, the tray in the second cassette goes up.

### (Manual Feed Operation)

The manual feed operation is controlled, for example, in the manner as described below.

(1) First, the manual feed sensor 13 detects a sheet.

(2) A manual feed pickup solenoid (not shown) is turned ON, and the manual feed pickup roller 3 goes down.

(3) A manual feed clutch (not shown) is turned ON, the manual feed pickup roller 3, the manual feed roller 1, and the manual conveyance roller 15 are rotated, and paper feeding is started.

(4) When the leading end of the sheet turns ON the manual feed sensor 14, the manual feed pickup solenoid is turned OFF, and the manual feed pickup roller 3 goes up.

(5) The leading end of the sheet turns ON the register sensor 26, and the position of the sheet is adjusted by the register rollers 11 and 12.

(6) The manual feed clutch (not shown) is turned OFF, and the manual feed pickup roller 3, the manual feed roller 1, and the manual conveyance roller 15 are stopped.

(7) The register motor is turned ON, and the sheet is conveyed in the transfer direction.

The cassette paper feed is controlled, for example, in the manner as described below.

### (Control of Second Cassette)

(1) A paper feed clutch (not shown), and a conveyance clutch (not shown) are turned ON, the pickup roller 10, the paper feed roller 8, and the conveyance roller 7 are rotated, and paper feeding is started.

(2) When the leading end of a sheet turns ON the second cassette paper feed sensor 20, the paper feed clutch and the conveyance clutch are turned OFF, and then, the conveyance clutch is turned ON.

(3) The leading end of the sheet turns ON the register sensor 26, and the position of the sheet is adjusted by the register rollers 11 and 12.

(4) The conveyance clutch is turned OFF, and the conveyance roller 7 is stopped.

(5) The register motor and the conveyance clutch are turned ON, and the sheet is conveyed in the transfer direction.

### (Control of First Cassette)

(1) The paper feed clutch and the conveyance clutch are turned ON, the pickup roller 6, the paper feed roller 4, and the conveyance roller 7 are rotated, and paper feeding is started.

(2) When the leading end of the sheet turns ON the first cassette paper feed sensor 16, the paper feed clutch and the conveyance clutch are turned OFF, and then, the paper feed clutch and the conveyance clutch are turned ON.

(3) The leading end of the sheet turns ON the register sensor 26, and the position of the sheet is adjusted by the register rollers 11 and 12.

(4) The paper feed clutch and the conveyance clutch are turned OFF, and the conveyance roller 7 is stopped.

(5) The register motor and the conveyance clutch are turned ON, and the sheet is conveyed in the transfer direction.

### (Adjustment of Pressurization Force)

In the image forming apparatus in which image formation is performed on plural kinds of sheets, in order to obtain excellent image formation, it is appropriate to change the conveyance pressurization force of a sheet according to the kind of the sheet such as paper thickness.

In the image forming apparatus of the embodiment, a media sensor to detect the kind of a sheet, such as paper thickness, is mounted, and according to the detection result, the pressurization force of the sheet conveyance roller is controlled, and the conveyance pressurization force suitable for the sheet is applied.

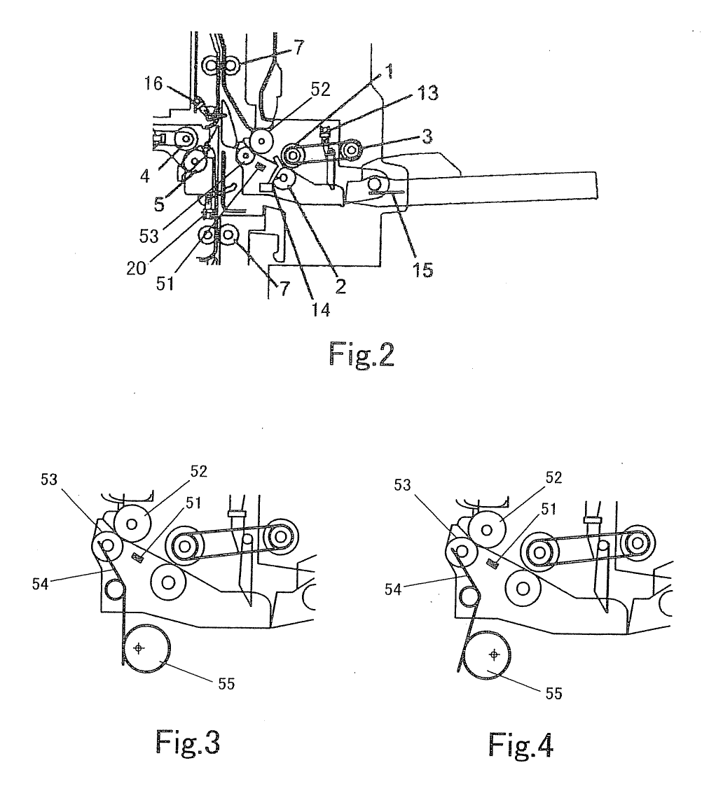

The pressurization force adjustment in the case where a sheet is conveyed from the manual feed tray 32 will be described. FIG. 2 is a view showing an adjustment unit of the pressurization force of the sheet conveyance roller. In FIG. 2, sheets set on the manual feed tray 32 are fed by the pickup roller 3, and are peeled and conveyed one by one by the separation roller 2 and the paper feed roller 1. The sheet having passed through the separation roller 2 reaches the sheet presence or absence detection sensor 14, and then is conveyed for a specified time, reaches the media sensor 51, and is stopped.

The media sensor 51 is for measuring the paper thickness of a sheet as a medium to be recorded. When a laser light is irradiated to the sheet, a speckle pattern generated by surface scattering is generated on the sheet. The speckle pattern is measured by a sensor such as a CCD, and the kind of the sheet can be determined from an intrinsic pattern due to the roughness of the sheet.

In general, a sheet is commercially available, and the kind is roughly classified into a normal paper and a thick paper. The thick paper can also be classified into four to five kinds.

Incidentally, the determination of the kind of the sheet by the media sensor 51 is not limited to the analysis of the speckle pattern, and it can be detected by the variation amount of a roller on a conveyance path of a paper feed unit. Besides, a pair of combined electrodes between which a fed sheet is sandwiched are disposed on the conveyance path of the paper feed unit, and a change in electrostatic capacity between the electrodes can also be detected.

The intensity of the pressurization force of the conveyance pressurization roller 53 is changed according to the paper thickness detected by the media sensor 51. In the tough thick paper, the pressurization of the conveyance roller is made high to increase the conveyance force. By that, a conveyance margin can be made large. When the conveyance margin becomes large, the sheet becomes hard to slide in the conveyance. In the case of the thick paper, when the pressurization force is adjusted so that the drawing load at the conveyance roller becomes 200 gf or more, for example, 500 to 700 gf, the conveyance margin becomes sufficient.

On the other hand, in the weak normal paper or thin paper, when the pressurization of the conveyance roller is made excessively high, there occur harmful effects such as occurrence of wrinkles and roller tracks. Then, in the normal paper or the thin paper, it is appropriate to adjust the pressurization force so that the drawing load at the conveyance roller becomes, for example, 200 gf or less.

FIG. 3 is a view for explaining the adjustment of the pressurization force of the sheet conveyance roller in a case of a thin paper or a normal paper. In the weak normal paper or thin paper, in order not to make the pressurization of the conveyance roller excessively high, with respect to the conveyance roller 52 which is the main conveyance roller, a spring 54 to apply the pressurization force to the conveyance pressurization roller 53 is located at a low load position.

On the other hand, FIG. 4 shows a case of a thick paper and is a view for explaining the adjustment of pressurization force of the sheet conveyance roller. In the tough thick paper, it is necessary that the pressurization of the conveyance roller is made high, so that the sheet is hard to slide. Then, an adjustment is made such that an eccentric cam 55 is rotated to make the load of the spring 54 high and also to make the pressurization of the conveyance pressurization roller 53 high.

In this embodiment, although the load is changed by the rotation of the eccentric cam, the pressurization force can be changed by actuating a slide lever by a solenoid, or the pressurization is released and the conveyance pressurization roller 53 can also be separated from the conveyance roller 52.

In the embodiment, although the conveyance pressurization force in the manual feed unit is changed, it is needless to say that also in the cassette paper feed, the conveyance pressurization force can be similarly changed by detecting the paper thickness or the like of a sheet by the media sensor 51.

A control may also be made such that the changing operation of the conveyance pressurization force is performed at the first sheet of plural set sheets, and with respect to the second sheet to the final sheet, stop and paper thickness detection by the media sensor 51 and the changing of the conveyance pressurization force are not performed.

In the image forming apparatus, although a thick paper or a thin paper can be used in addition to a normal paper, there is a case where an unusable sheet is set on the paper feed cassette or the manual feed tray. In that case, when image formation is forced, appropriate image formation can not be assured.

Then, in the case where it is determined by the media sensor that originally unusable sheets are set, it is appropriate that the image forming operation is stopped, or displaying is performed on a control panel or the like.

Hereinafter, a second embodiment will be described.

As a place where a sheet is set, paper feed cassettes 30 and 31 and a manual feed tray 32 are prepared in an image forming apparatus. For example, with respect to the kind of a sheet usable in the image forming apparatus, a sheet of 64 to 105 g/m² can be used in the paper feed cassettes 30 and 31, and a sheet of 64 to 209 g/m² can be used in the manual feed tray 32.

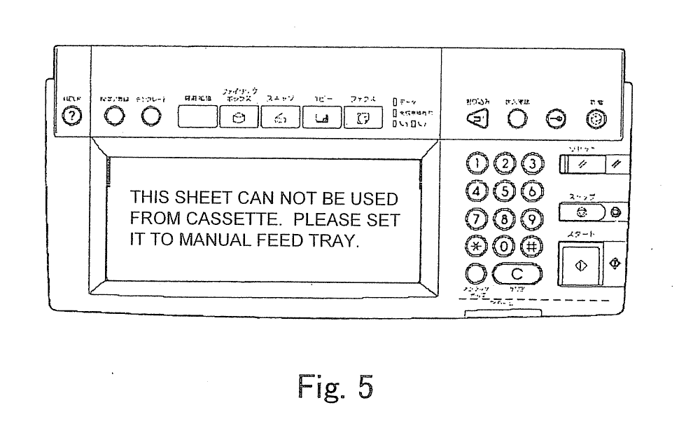

It is assumed that a user erroneously sets a paper of 163 g/m² on the paper feed cassette 30 or the paper feed cassette 31. With respect to the fed and conveyed sheet, the kind of the sheet is determined by the media sensor. It is found that the sheet out of spec is set in the paper feed cassette. Then, the image formation operation is stopped, and as shown in FIG. 5, it is displayed on the control panel that a tray on which the sheet is to be set is different. The user newly sets the paper of 163 g/m² on the manual feed tray 32.

In this case, the image formation operation is not stopped, and attention to disadvantage caused by continuous use may be displayed on the control panel.

Besides, in the case where a sheet unsuitable for both the paper feed cassettes 30 and 31 and the manual feed tray 32 is used, a display that any paper feed means can not be used may be performed on the control panel.

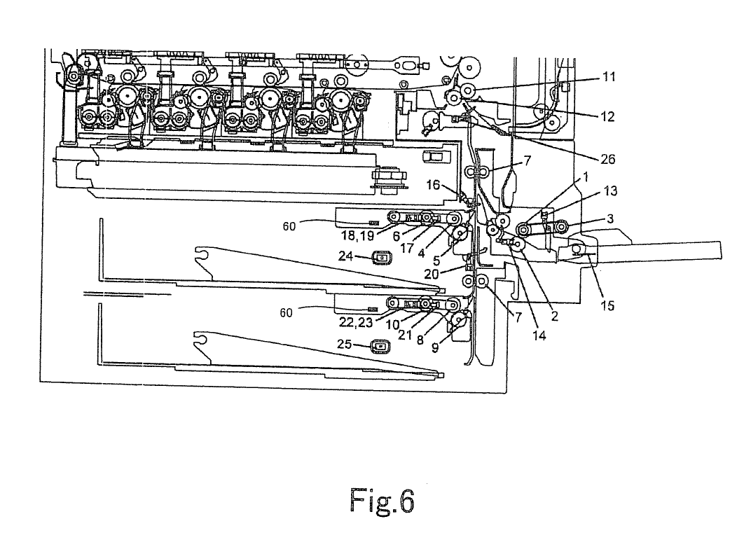

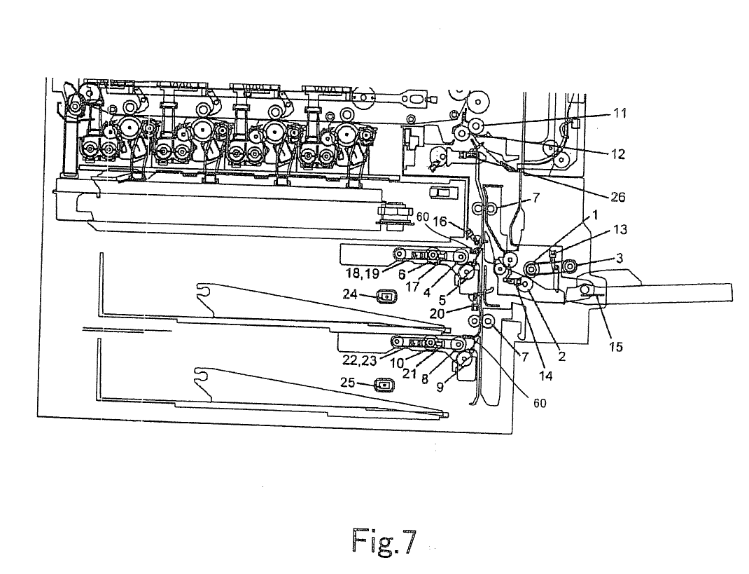

As shown in FIG. 6, media sensors 60 can be disposed inside the paper feed cassettes 30 and 31. In this case, before the sheet is fed or conveyed from the paper feed cassette to the image forming apparatus main body, the kind of the sheet can be determined. Thus, at an early stage, disadvantage of image formation can be prevented by stopping the image formation operation or by the display on the control panel. Besides, as shown in FIG. 7, media sensors 60 can also be disposed in the vicinities of exits of paper feed cassettes 30 and 31.

Incidentally, in the embodiment, although the description has been made on the case where the kind of a usable sheet is different between the paper feed cassette and the manual feed tray, no limitation is made to this. That is, with respect to the kind of a sheet usable in the image forming apparatus, the same kind of sheets can be used in the paper feed cassettes 30 and 31 and the manual feed tray 32.

As described above, according to the image forming apparatus of the embodiment, the conveyance pressurization force is automatically changed according to the kind of the sheet such as paper thickness, so that a suitable conveyance force can be applied while an erroneous operation is prevented. Besides, with respect to a sheet fed from each of paper feed means, the kind is determined, and the image formation is preformed using the sheet usable in the image forming apparatus, and therefore, it is possible to prevent poor conveyance, poor fixing, wrinkles and the like from occurring.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus including an image forming unit and for performing conveyance control according to a kind of a medium to be recorded, comprising:
a media sensor to detect a paper thickness of the fed medium to be recorded;
a conveyance roller to convey the medium to be recorded to the image forming unit;
a pressurization force member to apply a pressurization force to the conveyance roller; and
an adjustment mechanism to adjust the pressurization force of the pressurization force member according to the paper thickness of the medium to be recorded detected by the media sensor.

2. The image forming apparatus according to claim 1, wherein
the pressurization force to be applied to the conveyance roller is adjusted and a drawing force of the medium to be recorded from the conveyance roller is 200 gf or more, when the medium to be recorded detected by the media sensor is a thick paper.

3. The image forming apparatus according to claim 1, wherein
the pressurization force to be applied to the conveyance roller is adjusted and a drawing force of the medium to be recorded from the conveyance roller is 200 gf or less, when the medium to be recorded detected by the media sensor is a thin paper.

4. The image forming apparatus according to claim 1, wherein
the conveyance roller includes a main conveyance roller and a conveyance pressurization roller which is disposed to be opposite to the main conveyance roller and to which the pressurization force is applied from the pressurization force member.

5. The image forming apparatus according to claim 1, wherein
the pressurization force member is a spring member, and the adjustment mechanism includes an eccentric cam.

6. The image forming apparatus according to claim 1, wherein
the adjustment mechanism includes a slide lever and a solenoid.

7. The image forming apparatus according to claim 1, wherein
in a case where a plurality of media to be recorded are set, adjustment of the pressurization force to the conveyance roller is performed at the first medium to be recorded, and with respect to the second and following media, paper thickness detection in the media sensor and the adjustment of the conveyance pressurization force are not performed.

8. An image forming apparatus including an image formation unit and for performing image formation according to a kind of a medium to be recorded, comprising:
a plurality of paper feed units on which media to be recorded are set;
a media sensor to detect a paper thickness of the fed medium to be recorded; and
a control panel to guide an operation of the image formation;
wherein in a case where it is determined that the medium to be recorded detected by the media sensor is beyond the scope of specifications of the set paper feed unit, an image formation operation is stopped, and it is displayed on the control panel that the paper feed unit on which the medium to be recorded is to be set is different.

9. An image forming apparatus including an image formation unit and for performing image formation according to a kind of a medium to be recorded, comprising:
a plurality of paper feed units on which media to be recorded are set;
a media sensor to detect a paper thickness of the fed medium to be recorded; and
a control panel to guide an operation of the image formation;
wherein in a case where it is determined that the medium to be recorded detected by the media sensor is beyond the scope of specifications of the set paper feed unit, it is displayed on the control panel that the paper feed unit on which the medium to be recorded is to be set is different.

10. The image forming apparatus according to claim 8 or 9, wherein the paper feed unit includes a plurality of paper feed cassettes and a manual feed tray.

11. The image forming apparatus according to claim 8 or 9, wherein a plurality of paper feed cassettes correspond to sheets with different sheet thicknesses.

12. The image forming apparatus according to claim 8 or 9, wherein a plurality of paper feed cassettes correspond to the same kind of sheets.

13. The image forming apparatus according to claim 10, wherein the plurality of paper feed cassettes and the manual feed tray correspond to the same kind of sheets.

14. The image forming apparatus according to claim 10, wherein the media sensor is disposed in the paper feed cassette.

15. The image forming apparatus according to claim 10, wherein the media sensor is disposed in a vicinity of a sheet exit of the paper feed cassette.

16. The image forming apparatus according to claim 8 or 9, wherein in a case where the image formation of a sheet out of spec is approved, the image formation is carried out by the operation of the control panel.
